(19) United States
(12) Patent Application Publication
(10) Pub. No.: US 2012/0260324 A1
(43) Pub. Date: Oct. 11, 2012

(54) METHOD AND A SYSTEM FOR VALIDATING IDENTIFIERS

(75) Inventors: James Evan Lenon, Unley (AU); Jason Frederick Bender, Glen Osmond (AU)

(73) Assignee: EMUE HOLDINGS PTY LTD., Melboume (AU)

(21) Appl. No.: 13/505,718

(22) PCT Filed: Nov. 5, 2010
(86) PCT No.: PCT/AU2010/001470

§ 371 Date: May 29, 2012

(30) Foreign Application Priority Data
Nov. 6, 2009 (AU) 20090905437

(51) Int. Cl. G06F 21/00

(52) U.S. Cl. 726/6

(57) ABSTRACT

A method of validating an identifier is disclosed. In one embodiment an authenticating party system receives an identifier for validation and determines a first validation code associated with a current value of a counter. The first validation code is compared with the received identifier and, in the event that the identifier does not match the first validation code, the authenticating party system compares the identifier with one or more further validation codes associated with respective other values for the counter, said respective other values comprising N consecutive counter values succeeding the current value of the counter. If the identifier matches one of the further validation codes associated with a respective other value for the counter, the current value of the counter is updated to correspond with the respective other value for the counter associated with the matching further validation code.

This application claims priority from Australian Provisional Patent Application No. 2009905437 filed on 6 Nov. 2009, the contents of which are to be taken as incorporated herein by this reference.

### FIELD OF THE INVENTION

The present invention relates generally to a method and system for validating identifiers, and relates more particularly to a method and system for validating dynamic identifiers, such as a one-time pass code (OTP) or a dynamic card verification value (dCVV). In a typical application a method or system in accordance with an embodiment of the invention may be used to validate a dynamic identifier for authenticating a user during an electronic transaction.

### BACKGROUND OF THE INVENTION

In many electronic authentication systems a user is required to authenticate themselves to the system by providing proof that they are authorised to access a room, vehicle or electronic funds. One approach for authenticating a user involves the user providing an identifier, such as a secret code or personal identification number (PIN), for validation by an authenticating party's authentication system to authenticate the user. For example, during an electronic transaction involving electronic funds transfer, a user will typically provide an identifier which is processed by the authenticating party to verify that the user is an authorised user of the account, and thereby authorise the transaction. The identifier may include, for example, a static secret code, such as a PIN or, in the case of an electronic transaction involving a credit card, a card verification value (CVV). Provided that the user provides an identifier which is validated by the authenticating party, the user is authenticated and allowed to complete the transaction. Thus, in an electronic transaction involving a user and an authentication system, a significant requirement for a secure electronic transaction involves authenticating the user to the system. In other words, verifying that the user is who they claim to be.

One difficulty with static codes is that the same code is used each time the user authenticates with the system. This increases the risk of another party, such as an attacker, acquiring the code and thus conducting an unauthorised or fraudulent transaction. Hence, a problem associated with static validation systems is that if the static secret code or PIN is intercepted by an eavesdropper, the intercepted code or PIN may be subsequently used for fraudulent transactions.

One approach for addressing the above shortcomings of static codes involves providing the user with a device which generates a one-time useable identifier (in other words, a dynamic identifier), such as a dynamic card verification value, using an algorithm which uses a counter which increments on each transaction. On receipt of the identifier the authentication system independently generates an expected identifier using a similar algorithm to the one that generated the identifier at the device, and a local counter value. If the received identifier and the generated identifier match, the user is authenticated. Such approaches rely on the user device counter and the authentication system counter maintaining synchronisation. Unfortunately, in some circumstances it is possible that the counters may become unsynchronised, in which case the authentication system may be unable to validate a received identifier.

It would be desirable to provide a validation method which tolerates, at least to some extent, unsynchronised counters.

The above discussion of background art is included to explain the context of the present invention. It is not to be taken as an admission that any of the documents or other material referred to was published, known or part of the common general knowledge at the priority date of any one of the claims of this specification.

### SUMMARY OF THE INVENTION

According to one aspect of the present invention, there is provided a method of validating an identifier, the method comprising the steps of:
(i) receiving an identifier;
(ii) determining one or more validation codes corresponding to respective one or more counter values for a counter;
(iii) comparing the identifier with at least one of the one or more validation codes; and
(iv) if the identifier matches any one of the one or more validation codes, validating the identifier.

Preferably, determining the one or more validation codes includes determining a first validation code corresponding to a current value for the counter and determining one or more further validation codes each corresponding to a respective succeeding value for the counter. In one embodiment, determining the one or more validation codes includes determining a first validation code corresponding to the current value for the counter and determining one or more further validation codes each corresponding to a respective immediately succeeding value for the counter. The identifier may include a password, PIN, card verification value (CVV), credit card number, other number, message, network packet, string, character, array, data structure, or any other data. For example, the identifier may comprise a 3-digit or 4-digit value. The received identifier may include, for example, an identifier generated by an unauthenticated party operating a user device to execute a code generation algorithm with a local counter value stored on the user device as an input. The identifier may be generated by the user device using an algorithm which uses a local counter value from a counter on-board the user device, with the counter incrementing each time a transaction is conducted. The code generation algorithm may include, for example, an algorithm for generating a dynamic identifier in the form of a one-time password (OTP) or a card verification value (CVV). The algorithm may also take as input a secret key, such as a symmetric key that is shared between the user device and an authenticating party system for validating the identifier. The secret key may include a seed, code or data sequence, such as a 256-bit binary code.

Preferably, each validation code will be determined by executing, at the authenticating party system, the same code generation algorithm using a respective counter value for the counter at the authenticating party system as an input to the algorithm. The counter value may be incremented, decremented or otherwise varies in a predetermined fashion from the current counter value to the next or succeeding counter value. Thus, each validation code represents the identifier that the authentication party system expects to receive for a respective counter value if the user device counter and the authentication party system counter are synchronised correctly. Each counter may include, for example, a binary counter, such as a 16 bit binary counter.

The present invention thus enables an authenticating party system (that is, the validating system) to validate an identifier even if the current value of the counter at the authenticating party system and the value of the counter used to generate the identifier at the user device operated by the unauthenticated party become unsynchronised, thus resulting in the authenticating party system receiving an identifier having an unexpected value. This improves the usefulness of a dynamic identifier system using the present invention, as the authenticating party system is able to tolerate lack of synchronisation to a degree. The counters may become unsynchronised if, for example, the unauthenticated party operates the user device to generate an identifier without using it in an electronic transaction with the authenticating party system.

In an embodiment, the validation code corresponding to the current counter value (in other words, a first validation code) is determined and compared with the received identifier for validation. In the event that the received identifier does not match the validation code corresponding to the current value for the counter, the counter is incremented and a further validation code is then determined using the incremented value of the counter. The process of incrementing the counter, determining a further validation code corresponding to the incremented counter, and comparing the further validation code with the received identifier may involve an iterative process involving up to a predetermined number of iterations (N), and thus counter values. The predetermined number of iterations will correspond with the maximum number of validation attempts the authenticating party system will conduct to validate the received identifier. For example, up to ten validation codes corresponding to the ten counter values immediately succeeding the current value for the counter may be determined. In this respect, the immediately succeeding counter values form a “read ahead window” which may allow for successful validation of the received identifier even in the event that the value of the counter at the authenticating party system is out of synchronisation with counter at the user device by as many as, in this example, ten counter values. It will of course be appreciated that a lesser or greater number of succeeding counter values may be used. For example, in one embodiment the number of succeeding counter values may be between fifteen and twenty. However, a smaller number of succeeding counter values may improve the robustness of the validation method in terms of security.

Preferably the method further comprises, in the event that the received identifier does not match any one of the one or more validation codes:
(a) determining two or more synchronisation codes corresponding to respective two or more further counter values for the counter, the two or more synchronisation codes including a first synchronisation code comprising a validation code corresponding to a first value for the counter and a second synchronisation code comprising a validation code corresponding to a second value for the counter;
(b) comparing the identifier with the first synchronisation code;
(c) receiving a supplementary identifier;
(d) comparing the supplementary identifier with the second synchronisation code; and
(e) if the identifier matches the first synchronisation code and if the supplementary identifier matches the second synchronisation code, validating the identifier and/or the supplementary identifier.

The respective counter values to which the two or more synchronisation codes correspond preferably form a “synchronisation window”. Validation of identifiers using the synchronisation window may occur if the received identifier does not match any one of the one or more validation codes determined for the “read ahead window” described earlier. However, in one embodiment, matching of the identifier with the first synchronisation code alone does not result in successful validation of the identifier, but may instead prompt the authenticating party system to wait for a supplementary identifier (in the form of a further received identifier) which, if matched with the second synchronisation code, results in validation of the identifier and/or the supplementary identifier.

Preferably, if the identifier matches the first synchronisation code and if the supplementary identifier matches the second synchronisation code, the counter (that is, the counter at the authenticating party system) is incremented to the second value of the counter to thereby resynchronise the counter with the counter at the user device.

Preferably the first value and the second value for the counter are consecutive counter values.

Preferably, the two or more further counter values succeed the counter values used to determine the validation codes for the “read ahead window” described earlier. For example, in one embodiment, N consecutive counter values (for example, N=10) form the “read ahead” window, and the next M consecutive counter values form the “synchronisation window” with a window size of M. In one embodiment M>2N.

Incrementing the value of the counter at the authenticating party system to the second value of the counter may resynchronise the counter at the authenticating party system with the counter at the user device.

Preferably, the first value for the counter precedes the second value for the counter. More preferably the first value for the counter and the second value for the counter are consecutive values. In one embodiment, validating the supplementary identifier depends on the first value for the counter and the second value for the counter being consecutive values.

In some arrangements, where validation codes are determined by executing an algorithm which uses the value of the counter as an input, validation codes for counter values preceding the current counter value may not be able to be determined using the value of the counter. For example, in some embodiments the code generation algorithm may also use a secret key as input, with the secret key being modified from transaction to transaction, meaning that previous validation codes (in other words, validation codes corresponding to values for the counter which precede the current value) cannot be readily determine using the code generation algorithm. In an embodiment of the present invention, determining the one or more validation codes corresponding to respective one or more counter values for the counter includes obtaining one or more stored validation codes corresponding to respective one or more counter values immediately preceding the current value for the counter. Thus, as the current counter value increments, decrements or otherwise varies in a predetermined fashion, these stored validation codes may correspond to, or be associated with, counter values that precede the current counter value.

The stored validation codes may comprise validation codes determined for a respective value of the counter, but which have not been matched with a received identifier. For example, each validation code which does not match the received identifier may be stored in a “read back” window storing one or more validation codes determined for respective one or more counter values preceding counter values.

Preferably, each of the stored one or more validation codes are associated with a validation flag for indicating occurrence of validation by the respective stored validation code such that only stored one or more determined validation codes indicated as not having been used to validate a received identifier are available for comparison with the received identifier.

Preferably, each of the stored one or more validation codes are associated with a validity period establishing a time period during which the or each stored validation code is available for validating a received identifier, such that the or each stored validation code is unavailable for validating a received identifier after expiry of the validity period.

According to another aspect of the present invention, there is provided a method of validating a plurality of identifiers comprising:
(i) receiving a first identifier;
(ii) determining one or more first validation codes corresponding to respective one or more values for a counter;
(iii) comparing the first identifier with the one or more first validation codes;
(iv) if the first identifier matches any one of the one or more first validation codes, validating the first identifier;
(v) receiving a second identifier;
(vi) determining one or more second validation codes corresponding to respective one or more further values for the counter, the number of the one or more second validation codes being different from the number of the one or more first validation codes;
(vii) comparing the second identifier with the one or more second validation codes; and
(viii) if the second identifier matches any one of the one or more determined second validation codes, validating the second identifier.

Preferably, the number of the one or more determined second validation codes is less than the number of the one or more determined first validation codes. For example, a first identifier may be received and compared with a first predetermined number of validation codes for validation. Subsequently, a second identifier may be received and compared with a lesser predetermined number of validation codes for validation. This approach may allow, for example, the read ahead window for a first validation attempt to be different in size to a subsequent validation attempt.

According to yet another aspect of the present invention, there is provided a system for validating an identifier, the system comprising:
(i) an input for receiving an identifier;
a memory for storing:
   data representing the identifier; and
   data representing one or more validation codes corresponding to respective one or more counter values; and
(ii) a processor configured to:
   determine the one or more validation codes;
   compare the received identifier with at least one of the one or more determined validation codes; and
   if the received identifier matches any one of the one or more determined validation codes, validate the received identifier.

According to a further aspect of the present invention there is provided a method of validating an identifier during an electronic transaction between an unauthenticated party and an authenticating party, including:
an authenticating party system receiving the identifier for validation;
determining, by the authenticating party system, a first validation code associated with a current value of a counter;
comparing the received identifier with the first validation code;
responsive to the comparison, and in the event that the identifier does not match the first validation code, the authenticating party system comparing the identifier with one or more further validation codes, each further validation code associated with a respective other value for the counter from within a validation window of counter values; and
validating the identifier if the identifier matches one of the further validation codes.

A method according to the further aspect of the present invention may further include, in the event that the identifier matches one of the further validation codes associated with a respective other value for the counter, updating the current value of the counter to correspond with the respective other value for the counter associated with the matching further validation code. In this way, the current value of the counter at the authenticating party system may be synchronised with the counter at the user device.

According to yet another aspect, the present invention provides a method of validating an identifier during an electronic transaction between an unauthenticated party device and an authenticating party system, including in response to receiving an unexpected identifier at the authenticating party system:
incrementing a counter from a current count value in each of a plurality of successive iterations up to a predetermined number (N) of iterations;
for each of the successive iterations:
   determining a validation code corresponding with the incremented counter value;
   comparing the received identifier with the validation code associated with the incremented counter value; and
   in the event that the identifier matches the validation code associated with the incremented counter value, validating the identifier and storing the incremented counter value as the current count value.

According to still another aspect, the present invention provides a method of validating an identifier during an electronic transaction between an unauthenticated party and an authenticating party, including:
an authenticating party system receiving the identifier for validation;
determining, by the authenticating party system, a first validation code associated with a current value of a counter;
comparing the received identifier with the first validation code;
responsive to the comparison, and in the event that the identifier does not match the first validation code, the authenticating party system comparing the identifier with one or more further validation codes associated with respective other values for the counter, said respective other values comprising N consecutive counter values succeeding the current value of the counter; and
in the event that the identifier matches one of the further validation codes associated with a respective other values for the counter, updating the current value of the counter to correspond with the respective other value for the counter associated with the matching further validation code.

According to yet another aspect, the present invention provides an authenticating party system including:
a communications port;
a processor;
a memory storing a current value of a counter; and
software resident in memory accessible to the processor, the software including a series of instructions executable by the processor to carry out any one of the methods described above.

The present invention also extends to a system including:
an authenticating party system as described above; and
a user device including:
   an input for receiving a value;
   a processor;
   a memory storing a current value of a counter; and
   software resident in memory accessible to the processor, the software including a series of instructions executable by the processor to carry out a method of determining an identifier associated with the current value of the counter; and
   an output for outputting the identifier for communicating to the authenticating party system via a communications network for validation by the authenticating party system.

Finally, the present invention provides software including a series of instructions executable by a processor to carry out any one of the methods described above, and a computer readable media containing the software.

### BRIEF DESCRIPTION OF THE ACCOMPANYING DRAWINGS

The following description refers in more detail to the various features and steps of the present invention. To facilitate an understanding of the invention, reference is made in the description to the accompanying drawing where the invention is illustrated in a preferred embodiment. It is to be understood however that the invention is not limited to the preferred embodiment illustrated in the drawing.

In the drawings:

FIG. 1 is a schematic diagram of an example network including an authenticating party system and user devices according to embodiments of the present invention;

FIG. 2 is a block diagram of an authenticating party system according to an embodiment;

FIG. 3 is a block diagram of a user device suitable for use with an embodiment of the present invention;

FIG. 4 is a table showing an example relationship between counter values and validation codes suitable for use with embodiments of the present invention;

FIG. 5 is a flow chart of a method of validating an identifier according to an embodiment;

FIG. 6 is a flow chart showing another embodiment of a method of validating an identifier according to the present invention; and

FIG. 7 is a flow chart showing further operations suitable for appending to the method shown in FIG. 6.

### DETAILED DESCRIPTION OF EMBODIMENTS OF THE INVENTION

The present invention relates generally to a method and a system for validating identifiers such as numbers, letters or alphanumeric values. The invention may be applicable to situations where a first party (an authenticating party) attempts to authenticate the identity of a second party (a party to be authenticated, or an unauthenticated party). Authentication may be achieved by requesting the second party to provide an identifier to be validated by the first party. The two parties are typically equipped with their own counters, which may increment, decrement or otherwise vary their counter values in synchronisation to facilitate validation of the identifier. The authenticating party is usually a local server, such as a credit card issuing bank. The party to be authenticated, or the unauthenticated party, is usually a remote client, such as a credit card user attempting to authorise an online credit card transaction.

### Example of a Network

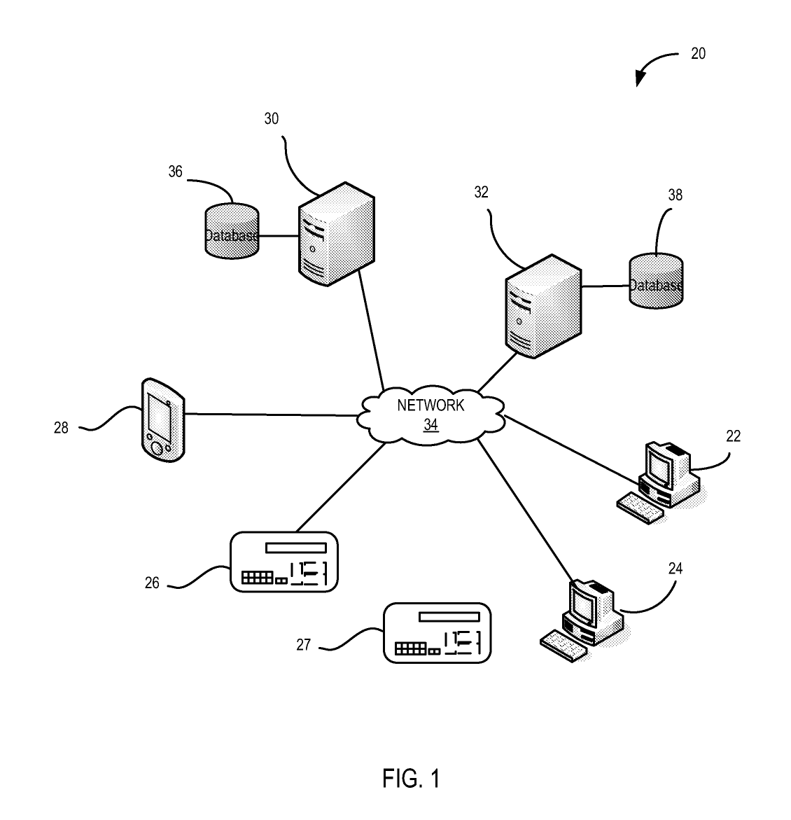

Embodiments of the present invention can be realised over a communications network, an example of which is shown in FIG. 1. The network 20 shown in FIG. 1 includes one or more user devices and one or more authenticating party systems. In this example, the user devices include personal computers (PCs) 22 and 24, smart cards 26 and 27, and a hand held device 28. The authenticating party systems include servers 30 and 32. As shown, user devices 22 to 28 and authenticating party systems 30, 32 are connected to support electronic data communication via the communications network 34.

The transfer of data over the network 34 may involve wired or wireless data communication. The authenticating party systems 30 and 32 can facilitate the transfer of data over the network 34 and one or more databases, such as database 36 and 38 respectively.

It will be appreciated that embodiments of the invention may be realised over different communications networks, such as a LAN (local area network), a mobile telecommunications network and the internet. Also, embodiments need not take place over a network, since some embodiments could occur entirely on a user device or authenticating party system.

### Example of an Authenticating Party System

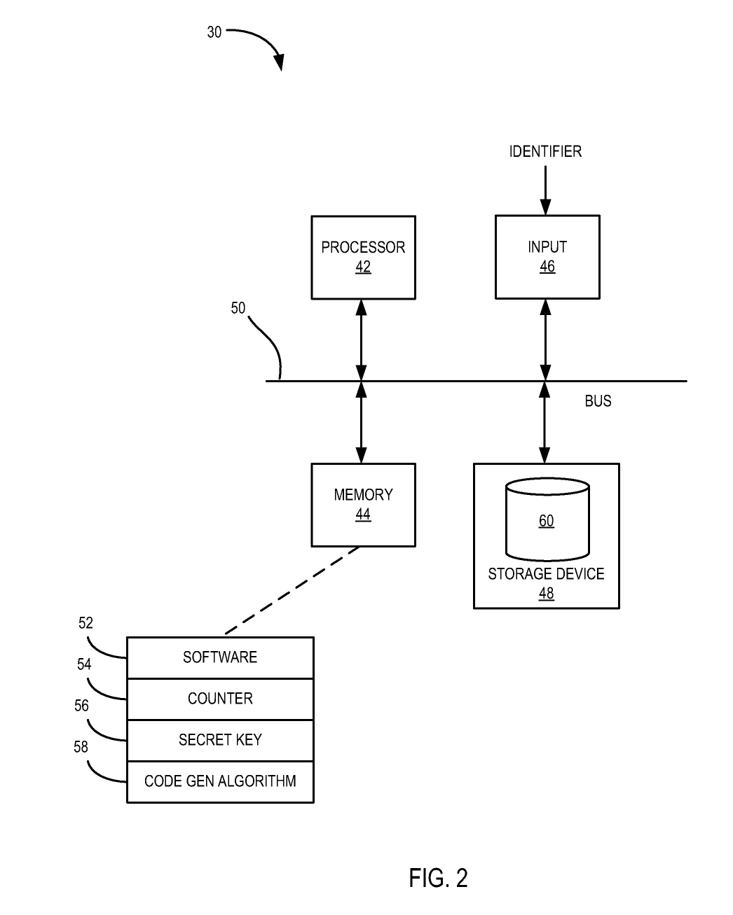

FIG. 2 shows a block diagram of an authenticating party system 30 according to an embodiment of the present invention. As shown, the authenticating party system 30 includes a processor 42, a memory 44, an input 46 (such as a communications port), and a storage device 48. As is shown, the components of the authenticating party system 30 are coupled via a bus or group of buses 50, such as data, address and/or control busses.

The processor 42 may include more than one processing device, for example to handle different functions within the authenticating party system 30. The memory 44 may include any suitable memory device and include, for example, volatile or non-volatile memory, solid state storage devices, magnetic devices, etc. The memory 44 stores a computer software program 52 for execution by the processor 42.

In the illustrated embodiment, the memory 44 also stores at least one counter 54 and at least one secret key 56. However, multiple counters and secret keys may be stored in the memory 44, or the database 60, each counter and secret key associated with a different user device. For example, if the authenticating party system 30 is for a financial institution, each counter 54 and secret key 56 may be associated with a particular account, or account holder. The memory 44 also stores a code generation algorithm 58 for generating a validation code. The code generation algorithm 58, for example, may take the current value of the counter 54 and the secret key 56 as input, and use a hashing function to generate a unique validation code. For example, a hashing function such as MD5, SHA-1, SHA-224, SHA-256, SHA-384 or SHA-512 may be used. For increased security the code generation algorithm 58 may additionally take a secret code or PIN as an input.

The storage device 48 may include any form of data or information storage means, for example, volatile or non-volatile memory, solid state storage devices, magnetic devices, etc. A file system and files may be stored on the storage device 48. The storage device 48 may house the database 60.

The input 46 allows the authenticating party system 30 to communicate with other devices via a hard wired or wireless network, such as network 34. A suitable communications ports may include an IEEE802.11 based wireless interface.

The authenticating party system 30 may be any form of terminal, server processing system, specialised hardware, computer, computer system or computerised device, personal computer (PC), mobile or cellular telephone, mobile data terminal, portable computer, Personal Digital Assistant (PDA), pager, smart card or any other type of device.

### Example of a User Device

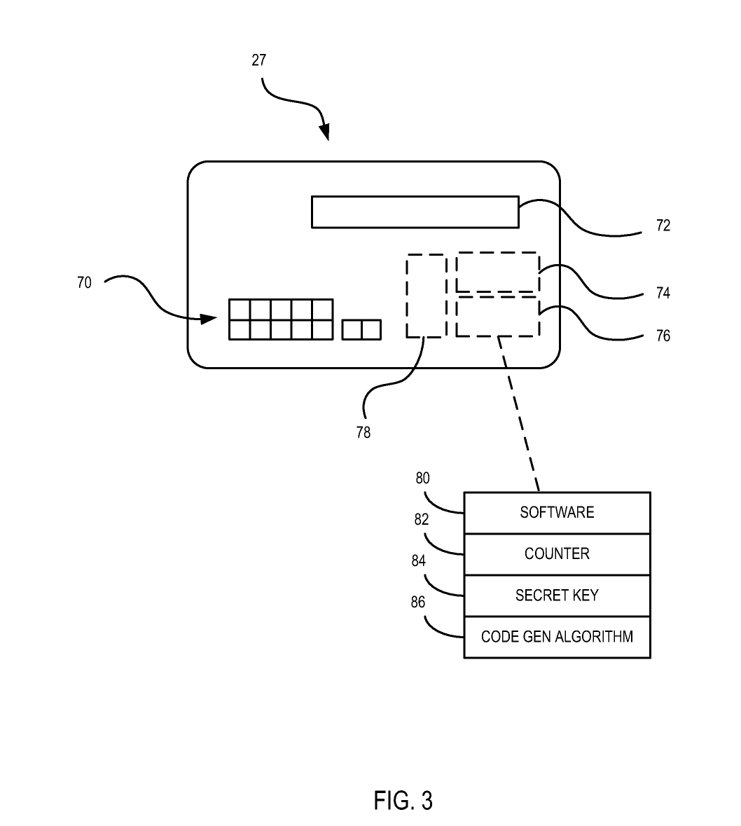

FIG. 3 shows a block diagram of a user device 27 according to an embodiment of the present invention. As shown, in this example the user device 27 is a smart card including an input in the form of a keypad 70, an output in the form of a display 72, a processor 74, a memory 76 and a power supply 78.

In this example, the keypad 70 is a 12 button keypad containing the digits 0 to 9, and two additional buttons for performing selections and controlling operation of the user device 27. A user may input a value, such as a PIN into the user device 27 using the keypad 70. The display 72 is an 8-digit alphanumeric LCD display.

The processor 74 is a microprocessor or microcontroller, for executing a computer software program 80 resident in the memory 76. An example of a suitable processor 74 is the 6502, ARM, Motorola 6800, Texas Instruments MSP430. The power supply 78 may include a battery or an induction coil, to supply electrical power to the processor 74 and other functional components of the user device 27.

The memory 76 includes read-only memory (ROM) (such as an EPROM or EEPROM) on-board the processor 74. However, it is possible that the memory 76 may be external to the processor 74. The memory 76 may also include a random access memory (RAM) to provide working memory for the processor 74.

The smart card may also function as a credit card or debit card, and may include a magnetic strip, integrated circuit or other components for storing further information associated with the card. This information may be readable by an appropriate reader for forwarding to the authenticating party system 30 (ref. FIG. 2). The smart card may also include a communications port, as described above, for data communication with an authenticating party system 30 (ref. FIG. 2).

Although the above described example of a user device 27 is in the form of a smart card, it is of course possible that other embodiments will be implemented in other forms. For example, the user device may include a mobile device equipped with suitable processing infrastructure, such as a mobile phone, a personal digital assistant (PDA), a laptop computer, a hand-held computer, or the like. Similarly, the user device 27 may include a desktop computer programmed with an executable software program. Thus, it will be appreciated that a user device 27 may be a number of different hardware ‘platforms’.

The memory 76 of the user device 27 stores a counter 82 and a secret key 84. The counter 82 and secret key 84 may be associated with a particular service, such as an electronic data interchange service (for example an on-line banking service, share trading service, an on-line shopping service, or the like), a computer network service (for example a network log-on service), a communications service (for example an email service or a messaging service), a membership based service (for example an on-line forum, a car-rental service, or a health service), a security service (for example a building access service), or the like.

The secret key 84 is a seed, code or data sequence, associated with the user device 27. In this example, the secret key 84 is a 256-bit shared key, stored in the memory 76 of the user device 27. The secret key 84 is the same as the secret key 56 associated with the unauthenticated party stored in the memory 44 of the authenticating party system 30 for the particular service. The counter 82 stored at the user device 27 is of the same type as the counter 54 stored at the authenticating party system 30, and may include, for example, a 16-bit counter. A 16-bit counter may support generation of up 65,536 identifier/validation codes. It will of course be appreciated that a small counter (i.e. a counter with less bits) may be used.

A code generation algorithm 86 is also stored in the memory 76, which is the same as the code generation algorithm 58 stored in the memory 44 of the authenticating party system 30.

### Examples of Validating Identifiers

As explained briefly above, embodiments of the present invention validate identifiers, such as numbers, letters or alphanumeric values, during a validation process which authenticates a user (that is, the unauthenticated party) to an authenticating party system. Authentication may be achieved by requesting the unauthenticated party to provide an identifier to be validated by the authenticating party system.

The unauthenticated party is typically equipped with a user device 27 and the authenticating party with an authenticating party system 30, each having a respective counter 82, 54, which they may increment, decrement or otherwise vary their counter values in synchronisation to facilitate validation of the identifier. The authenticating party is usually a local server, such as a credit card issuing bank. The party to be authenticated, or the unauthenticated party, is usually a remote client, such as a credit card user attempting to authorise an online credit card transaction.

At the user device 27 of the unauthenticated party, the user may enter a PIN into the keypad 70 and press a button to activate the software 80. The software 80 may determine an identifier using the code generation algorithm 86 by taking the counter value from the counter 82, the secret key 84 and optionally the PIN as inputs. This identifier may include, for example, a three digit dynamic card verification value (for example, “179”), which is displayed on the display screen 72 of the user device 27. The user may then enter the identifier into a further user device, such as a personal computer for transmission to the authenticating party system 30 along with details of an electronic transaction, such as their account number, card number, account name or the like.

On receipt of the identifier, the software 52 at the authenticating party system 30 may determine a validation code in accordance with the same code generation algorithm 58 but taking the counter value from the counter 54, the secret key 56 and optionally the PIN associated with the unauthenticated party as inputs to the algorithm 58.

If the two counter values, and other information, taken at the two parties are identical, the identifier determined at the user device 27 will match the validation code determined at the authenticating party system 30. The identifier may then be validated and the identity of the unauthenticated party may be taken as authenticated. In this respect, “matching” may arise if the identifier is the same as the validation code. Alternatively, “matching” may arise if the identifier corresponds to the validation code in a predetermined way, such as having the same odd or even digits, or if the identifier is a prime factor of the validation code.

Each counter 54, 82 will, after a triggering event, increment, decrement or otherwise vary the current counter value in a predetermined fashion for providing a next or succeeding counter value. The next or succeeding counter value in turn can then be used as an input to the respective algorithm to determine the next or succeeding validation code, or the next or succeeding identifier, respectively.

At the authenticating party system 30, the triggering event may be the occurrence of the successful validation of an identifier. For example, the counter 54 at the authenticating party system 30 may be triggered to increment its counter value by one every time successful validation occurs. Similarly, at the user device 27 of the unauthenticated party, the triggering event may be the determination of a previous identifier. For example, the counter 82 stored in the user device 27 of the unauthenticated party may be triggered to increment its counter value by one every time an identifier has been determined by the code generation algorithm 86. Using the above examples of triggering events, every matching pair of identifier and validation code may only be determined and used for validation once.

The two counters 54, 82 at the two parties are ideally synchronised to produce synchronised counter values and thus matching identifier and validation codes. That is, the current counter value of the counter 54 at the authenticating party system 30 preferably has the same value as the current counter value of the counter 82 at the user device 27. However, in some circumstances it is possible that the triggering events for the two counters may differ (as in the above examples), which may result in the two counters being out of synchronisation.

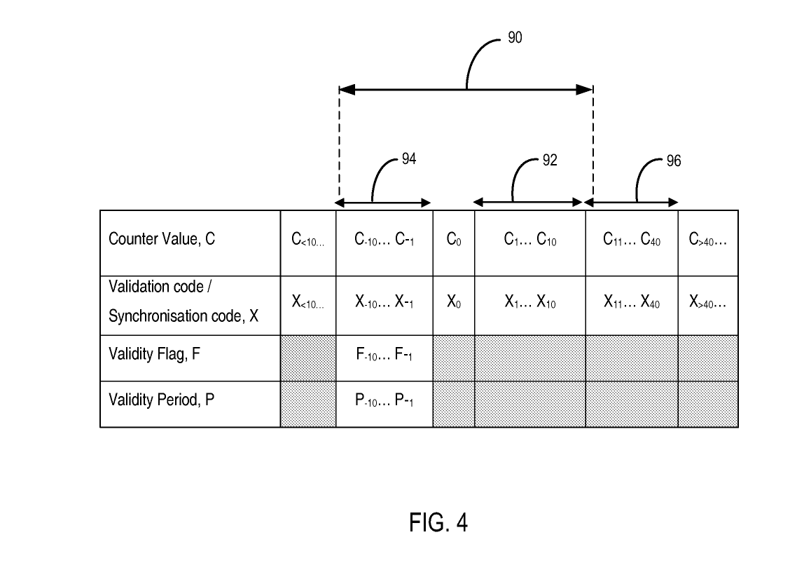

To allow for validation where the two counters 54, 82 are out of synchronisation, and with reference now to FIG. 4, embodiments of the present invention use one or more “validation windows” 90, such as a “read ahead window” 92, and/or a “read back” window 94, and/or a “synchronisation window” 96.

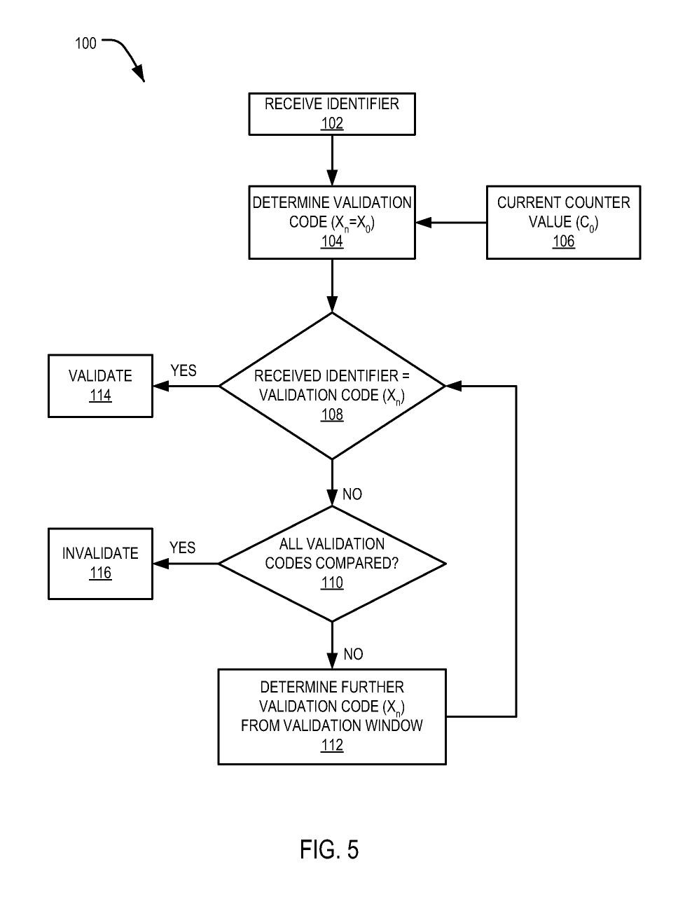

Turning now to FIG. 5, one embodiment of the present invention relates to a method 100 of validating an identifier for an electronic transaction. The method may, for example, be suitable to be carried out via software 52 at the authenticating party system 30.

As shown in FIG. 5, the method 100 includes the authenticating party system 30 receiving the identifier for validation at step 102; determining a first validation code (at step 104) associated with a current value of a counter 54 obtained at step 106; comparing the received identifier with the first validation code at step 108; at step 110, responsive to the comparison, and in the event that the identifier does not match the first validation code, iteratively comparing the identifier with each of one or more further validation codes from the validation window 90 (ref. FIG. 4) as determined at step 112; and at step 114 validating the identifier if the identifier matches one of the further validation codes, or invalidating (at step 116) the identifier, and declining the transaction, if the identifier does not match any one of the one or more further validation codes.

Thus, even if the current value of the counter at the user device 27 of the unauthenticated party and the authenticating party system 30 are out of synchronisation, the identifier determined at the user device 27 may nevertheless match one of the further validation codes determined at step 112, being the validation code determined using the same counter value as the counter value used to determine the identifier. The identifier may then be validated at step 114 and the identity of the unauthenticated party may be taken as authenticated. In other words, validation will occur if the counter value used to generate the identifier at the user device 27 is within the validation window 90, which may occur, for example, if the counter 54 at the unauthenticated party system 30 is behind the counter 82 at the user device 27 by an amount which is less than the size of the validation window.

Each of the further validation codes may be also be determined by obtaining a validation code previously determined for, and thus associated with, a counter value preceding the current counter value, and/or generating a validation code using the code generation algorithm 52 and the value for the counter, and possibly other information (for example, the secret key 56).

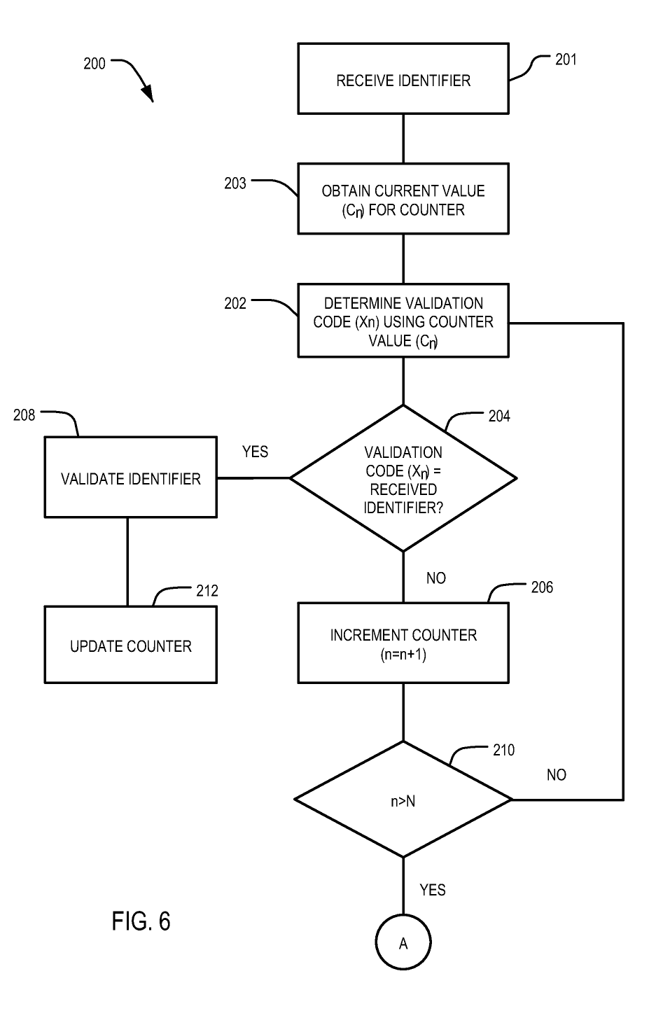

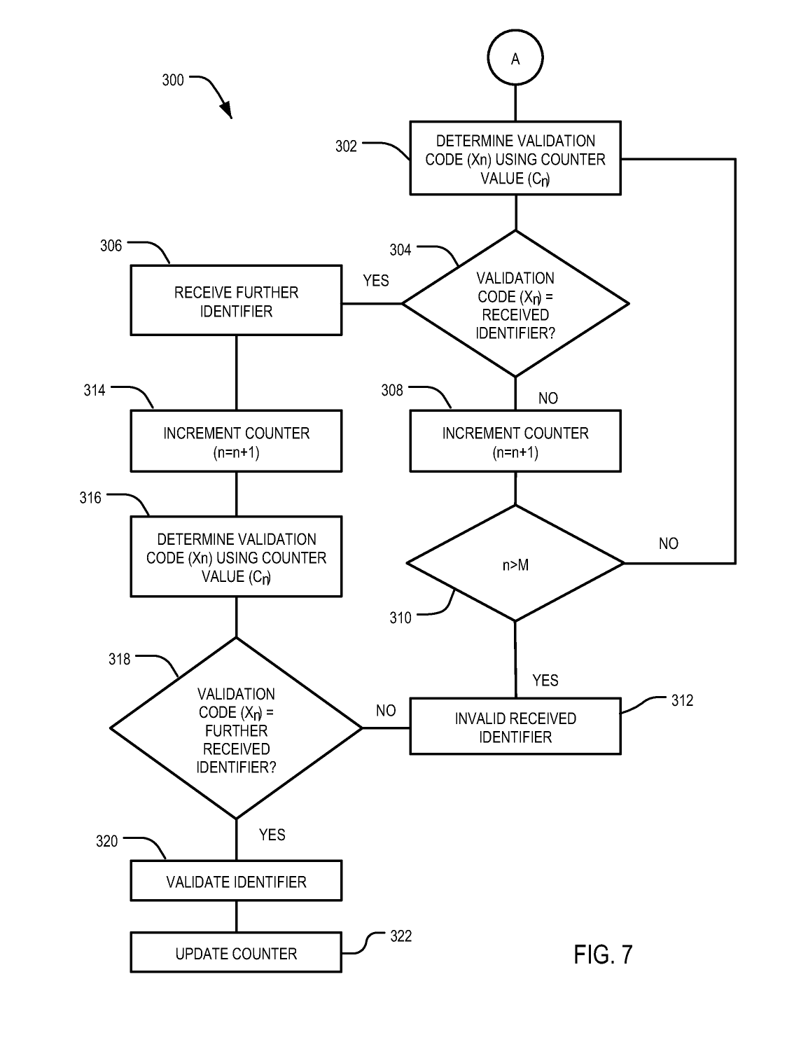

Examples of embodiments which use a read ahead window 92, a read back window 94, and a synchronisation window 96 will be described below with reference to the flow charts shown in FIG. 6 and FIG. 7.

### Read Ahead Window

As previously explained, and with reference now to FIG. 4, the validation window 90 may include a “read ahead window” 92.

A “read ahead window” may allow for successful validation even if the counter 82 at the user device 27 of the unauthenticated party is ahead of, and becomes out of synchronisation with, the counter 54 at the authenticating party system 30. Lack of synchronisation may arise if, for example, an identifier at the user device 27 has been determined using the code generation algorithm 86 (thereby triggering an increment of the counter value at the unauthenticated party), but is not received and validated by the authenticating party system 30 (thereby not triggering an increment of the counter value at the authenticating party system 30).

FIG. 6 shows a flow diagram for a validation process which uses a read ahead window 92 to validate an identifier for an electronic transaction. The method begins with the authenticating party system 30 receiving (at step 201) an identifier for the electronic transaction, such as a dynamic card verification value. The identifier may be entered into or communicated to the authenticating party system 30 with other information identifying the user, such as a credit card number, account number or the like.

At step 203 the authenticating party system 30 obtains the current value (Cₙ: n=0) for the counter 54 to be used to generate the validation code for the user and determines (at step 202) a first validation code (Xₙ: n=0) using the obtained current value. The first validation code is then compared with the received identifier (at step 204). If the first validation code does not match the received identifier the process continues as follows.

At the authenticating party system 30, after determining that the validation code corresponding to the current counter value does not match the received identifier, one or more further validation codes corresponding to respective succeeding counter values are alternatively or additionally determined by way of an iterative process. In the present case, determining each further validation code involves incrementing the counter 54 (at step 206), determining at step 210 whether the incremented counter exceeds the size (N) of the read ahead window and, if the value of the counter is within the read ahead window, determining a further validation code corresponding with the incremented counter value, or otherwise invalidating the identifier and declining the transaction. If during this process one of the determined validation codes matches the received identifier, the counter 54 (at step 212) is updated to the current value of the counter and the transaction is approved (at step 208).

In the example shown in FIG. 4, the validation codes which are determined and compared with the received identifier for validation, and which form the read ahead window, comprise ten validation codes X₁ . . . X₁₀ corresponding to the ten consecutive counter values C₁ . . . C₁₀ immediately succeeding the current counter value C₀. Hence, in this example, if the received identifier matches any one of the validation codes X₁ . . . X₁₀ successful validation occurs.

A read ahead window of ten counter values (i.e. a read ahead window size of 10) allows successful validation of the received identifier even if the counter 82 at the unauthenticated party system 30 is, for example, ahead of the counter 54 at the authenticating party system 30 by as many as ten counter values.

In example shown in FIG. 4, if the received identifier matches one of the validation codes X₁ . . . X₁₀ within the read ahead window 92, software 52 at the authenticating party system 30 updates the current value of the counter 54 to correspond with the respective value for the counter associated with the matching validation code (step 212 of FIG. 6). This resynchronises the counter 54 at the authenticating party system 30 with the counter 82 at the user device 27.

For each validation code X₁ . . . X₁₀ that does not match the received identifier, the software 52 at the authenticating party system 30 may store the validation code for validating a later received identifier. The storage of validation codes for later use will be described in more detail below.

As will be described in more detail later, the size (N) of the read ahead window 92 may be set or adjusted by the authenticating party as required. A smaller read ahead window size decreases the tolerance on desynchronisation, but increases the security of the validation system.

### Synchronisation Window

In some embodiments, if the received identifier does not match any one of the one or more validation codes within the read ahead window 92, a method in accordance with an embodiment of the present invention may nonetheless attempt to validate the identifier with the aid of a supplementary identifier, being a further received identifier. In such embodiments, and with reference now to FIG. 7, the method may further comprise comparing (at step 304) the received identifier with one or more synchronisation codes (in the form of additional validation codes) determined at step 302, each synchronisation code associated with a respective further value for the counter 54 from the synchronisation window 96, and iteratively comparing (via steps 302 to 308) each of the one or more synchronisation codes with the identifier until either a match is found, or the counter exceeds (at step 310) the size (M) of the synchronisation window. If the counter exceeds the size (M) of the synchronisation window, the identifier is invalidated (at step 312), in which case the validation process concludes and the transaction is declined. However, even if a match is found, the authenticating party system 30 does not validate the received identifier but instead marks or temporality stores the value of counter corresponding to the matching synchronisation code and declines the transaction. Upon receipt of the next identifier (at step 306), the authenticating party system 30 then determines (at step 316) the synchronisation code corresponding to the next value of the counter (as incremented at step 314), and in the event that the determined synchronisation code matches (at step 318) the further received identifier (thus indicating that the user has entered two consecutive valid identifiers), the further received identifier is validated (at step 320) and the counter 54 is updated (at step 322) to correspond with the counter value associated with the additional synchronisation code matching the further identifier.

In one embodiment, as shown in FIG. 4, the counter values within the synchronisation window 96 are consecutive. The corresponding synchronisation codes (being the additional validation codes X₁₁ to X₄₀) are thus the synchronisation codes which are compared with the identifier for a match.

Ideally the counter values for the synchronisation window succeed the counter values for the read ahead window. For example, in the embodiment as shown in FIG. 4, the ten counter values C₁ . . . C₁₀ form the read ahead window 92, whereas the next thirty counter values (i.e. C₁₁ . . . C₄₀) form the synchronisation window 96.

The validation codes X₁₁ . . . X₄₀ corresponding to counter values within the synchronisation window 96 may be determined using the code generation algorithm 86 in the same way as the validation codes corresponding to the counter values within the validation window 90 are determined, except that they correspond to a different window of counter values.

In terms of the example shown in FIG. 4, successful validation using the synchronisation window 96 may thus proceed as follows. The received identifier is first compared with the synchronisation codes X₁₁ . . . X₄₀. If the identifier matches with one of the synchronisation codes, the authenticating party system 30 does not yet validate the identifier but may request the unauthenticated party to send a supplementary or further identifier. Once received by the authenticating party system 30 the supplementary identifier is then compared with the immediately succeeding synchronisation code (that is, a second synchronisation code). For example, the identifier may match X₃₅ corresponding to counter value C₃₅, which as shown in FIG. 4 is outside the read ahead window 92 but within the synchronisation window 96. Then a supplementary or further identifier may be requested or provided and received by the authenticating party system 30. The supplementary identifier is then compared with X₃₆, being the synchronisation code immediately succeeding synchronisation code X₃₅. If a match between the supplementary or further identifier and X₃₆ is also found, the further identifier is validated, and the counter 54 is updated. In this example, the current counter value C₀ will be incremented to the counter value C₃₆.

In some embodiments, it is also envisaged that even if an initial received identifier is validated, the authenticating party system may still prompt for a supplementary identifier for the purpose of synchronising the counters.

### Read Back Window

In some embodiments, an identifier may be generated by the user device 27 of the unauthenticated party but not be received and processed by the authenticating party system 30 until after a certain time delay. During the time delay, a number of occurrences of validation may have taken place at the authenticating party system 30, and thus the counter 54 at the authenticating party system 30 may have been triggered a number of times and thus incremented past the counter value used by the user device 27 to generate identifiers. Thus, by the time the unprocessed identifier is finally received, the validation code determined, at the authenticating party system 30, using the current counter value of the counter 54 at the authenticating party system 30 will not match the received identifier. To allow such delayed validation of an identifier, one embodiment of the present invention employs a “read back window” 94 storing validation codes determined using values of the counter 54 which precede the current value. The stored validation codes will be validation codes which were determined for a respective value of the counter 54, but which did not, when so determined, match with the received identifier and thus have not yet been used to validate an identifier.

In one embodiment, as illustrated in FIG. 4, the validation codes X₋₁₀ . . . X₋₁ corresponding to the ten counter values C₋₁₀ . . . C₋₁ preceding the current value are stored in memory 44 or the storage device 48. These stored validation codes X₋₁₀ . . . X₋₁ may be accessed if the code generation algorithm 58 cannot determine validation codes corresponding to preceding counter values for the counter 54. In this example the stored validation codes X₋₁₀ . . . X₋₁ forming the read back window 94, as determined from the preceding ten counter values C₋₁₀ . . . C₋₁, are compared with the received identifier for “delayed” validation. Successful validation may occur if the received identifier matches any one of the stored validation codes X₋₁₀ . . . X₋₁. Hence, and referring again to FIG. 5, in one embodiment comparing the received identifier (at step 108) with at least one or more validation codes includes comparing the identifier with one or more stored validation codes previously determined for respective one or more counter values preceding the current value for the counter 54. An advantage of this approach is that it may allow a received identifier to be validated if the matching validation code corresponds with a value of the counter 54 which precedes the current value.

In a further embodiment, a validation flag (F₋₁₀ . . . F₋₁) may be associated with each of the stored validation codes X₋₁₀ . . . X₋₁ for indicating occurrence of validation by the respective stored validation code. In such a case, successful “delayed” validation by a stored validation code may only occur if there is no prior occurrence of validation by that stored validation code. This may prevent the same identifier from being validated by the same stored validation code more than once, which may otherwise lower the security of the validation system.

In a yet further embodiment, a validity period (P₋₁₀ . . . P₋₁) may be associated with each of the one or more stored validation codes. Typically the validity period may be set anytime between one day and one week. After the validity period expires, the stored validation code may be made invalid. This may prevent an identifier matching an expired stored validation code to be validated.

### Adaptive Read Ahead Reduction

In some embodiments of the invention, the size of the validation window 90 is adjustable. Indeed, a second aspect of the present invention relates to a method of validating a plurality of identifiers using a different validation window size. The method comprises the steps of (i) receiving a first identifier, (ii) determining one or more first validation codes corresponding to respective one or more first counter values, (iii) comparing the received first identifier with the one or more determined first validation codes, (iv) if the received first identifier matches any one of the one or more determined first validation codes, validating the received first identifier, (v) receiving a second identifier, (vi) determining one or more second validation codes corresponding to respective one or more second counter values, (vii) the number of the one or more second validation codes being different from the number of the one or more first validation codes, (viii) comparing the received second identifier with the one or more determined second validation codes; and (ix) if the received second identifier matches any one of the one or more determined second validation codes, validating the received second identifier.

By way of example, in one embodiment a first identifier is received and compared with twenty validation codes comprising a first validation code corresponding to the current counter value and further validation codes each corresponding to a respective one of the succeeding nineteen counter values. If the received first identifier matches any one of the twenty validation codes, the first identifier is validated. Thereafter, and provided that the first identifier was validated, the size of the validation window is reduced such that the next received identifier is compared with eighteen validation codes corresponding to the current counter value and the succeeding seventeen counter values. If the next received identifier matches any one of the eighteen validation codes, the received second identifier is validated. For every further identifier received, the number of validation codes for comparison may be decreased (for example, by two) until the number of validation codes reaches a minimum predetermined value, for example, ten. In other words, the read ahead window may have a size which decreases each time a validation attempt occurs. This approach may allow for an initial greater tolerance on desynchronisation of counters at the two parties to, for example, improve useability for new users. For example, as a new user gains experience by attempting validation for a number of times, the read ahead window may be decreased to increase security of the validation system. Such an approach thus reduces the degree to which variations in the counters 54, 82 will be tolerated as the user becomes more adapt at operating the user device 27, and thus less likely to cause synchronisation issues which may arise from improper use.

In one embodiment, the number of validation codes for comparison (i.e. the read ahead window size) does not decrease unless the previous identifier is successfully validated. However, in some embodiments, the read ahead window may have a size which varies in a predetermined way based on the number of validation processes conducted, or time. For example, the read ahead window may have a size determined by an predetermined initial value, and which then reduces over time, so that, for example, the read ahead window may have a size which is double the predetermined initial value for the first use by the user, 80% of the predetermined value for the second use, 60% of the predetermined value for the third use, and so forth.

It will thus be appreciated that adaptive read ahead reduction may involve various methods to reduce or increase the read ahead window size. The amount of the reduction or increase may be linear or may involve a suitable formula. By way of example, suitable methods may include:

1) Reduce the read ahead window size based on time, such as a time period since a first validation attempt. For example, when a user is assigned a card the read ahead window size may be set to X. After a certain period of time, say one week, the read ahead window size will automatically decrease. After another week the read ahead window size will further decrease again until after a further period of time (for example, one month) the read ahead window size is held constant.

2) Reduce the read ahead window size based on a predetermined number of validation attempts. For example, when a user is assigned the card the read ahead window size will be set to X. After each use the read ahead window size will decrease, say by two. After a predefined number of uses (for example, 20 validation attempts) the read ahead window size will be held constant.

3) Pass in a risk score for a user and have the read ahead window size based on the risk score or validation failure. For example, based on different criteria such as income, age or credit limit each user will be assigned a “risk score”. The read ahead window size may be set, or vary according to, the user's risk score. For example, a user with a lower risk score may have a “larger” read ahead window size and a user with a high risk score would have a “smaller” read ahead window size.

4) Increase the read ahead window size based on previous synchronization or validation failure. For example, a user that consistently gets their card out of synchronisation and thus who may need to contact, for example, a help desk service to re-establish synchronisation, may have their read ahead window size increased to reduce or minimise the chance of the card being out of synchronisation. This may allow, for example, the card issuer (such as a bank) to reduce interaction with the user to re-establish synchronisation.

Now that methods and systems for validating an identifier have been described, it should be apparent that embodiments of the present invention may provide the following advantages:

Validation of identifiers based on synchronised or near-synchronised counters is dynamic and has improved security over validation of static identifiers.

Validation of identifiers using a read ahead window allows for adjustable tolerance on desynchronisation.

Validation of identifiers using a synchronisation window and a supplemental identifier allows for re-synchronisation of counters.

Validation of identifiers using an adaptive read ahead window provides a balance between increased useability and increased security.

Validation of identifiers using a read back window allows for delayed validation.

It will be appreciated by persons skilled in the art that numerous variations and/or modifications may be made to the invention as shown in the specific embodiments without departing from the spirit or scope of the invention as broadly described. For example, the read ahead window size may be any size other than ten. The validity period associate with stored validation codes may be less than one day or more than one week.

1-33. (canceled)

34. A method of validating an identifier, the method comprising the steps of:
receiving an identifier;
determining one or more validation codes corresponding to respective one or more counter values for a counter;
comparing the identifier with at least one of the one or more validation codes; and
if the identifier matches any one of the one or more validation codes, validating the identifier.

35. A method according to claim 34, wherein the identifier includes a dynamic identifier.

36. A method according to claim 34, wherein determining the one or more validation codes includes determining a first validation code corresponding to a current value for the counter and determining one or more further validation codes corresponding to respective succeeding values for the counter.

37. A method according to claim 36, further including determining said one or more further validation codes corresponding to consecutive values for the counter succeeding the current value.

38. A method according to claim 34, further comprising, if the identifier does not match any one of the one or more validation codes:
determining two or more synchronization codes corresponding to respective two or more further values for the counter, the two or more synchronization codes including a first synchronization code comprising a validation code corresponding to a first value for the counter and a second synchronization code comprising a validation code corresponding to a second value for the counter;
comparing the identifier with the first synchronization code;
receiving a supplementary identifier;
comparing the supplementary identifier with the second synchronization code; and
if the identifier matches the first synchronization code and if the supplementary identifier matches the second synchronization code, validating the identifier and/or the supplementary identifier.

39. A method according to claim 38, wherein the further values for the counter comprise up to M consecutive values succeeding N consecutive values succeeding a current value for the counter.

40. A method according to claim 39, wherein M is greater than N.

41. A method according to claim 38, further comprising, if the identifier matches the first synchronization code and if the supplementary identifier matches the second synchronization code, incrementing a current counter value to the second counter value.

42. A method according to claim 38, wherein validating the supplementary identifier further depends on the first value for the counter and the second value for the counter being consecutive values.

43. A method according to claim 34, further including, for any validation code not matching the identifier, storing the validation code for validating a further received identifier.

44. A method according to claim 43, further including associating a validation flag with each of the one or more stored validation codes for indicating occurrence of validation using the respective stored validation code.

45. A method according to claim 43, further comprising associating a validity period with each of the one or more stored validation codes.

46. A method according to claim 43, wherein determining the one or more validation codes includes obtaining one or more stored validation codes previously determined for respective one or more counter values preceding a current value for the counter.

47. A method according to claim 34, further comprising:
receiving a second identifier;
determining one or more second validation codes corresponding to respective one or more second counter values, the number of the one or more second validation codes being different from the number of the one or more first validation codes;
comparing the second identifier with the one or more second validation codes; and
if the second identifier matches any one of the one or more determined second validation codes, validating the second identifier.

48. A system for validating an identifier, the system comprising:
an input for receiving an identifier;
a memory for storing:
data representing the identifier; and
data representing one or more validation codes corresponding to respective one or more counter values; and
a processor configured to:
determine the one or more validation codes;
compare the received identifier with at least one of the one or more determined validation codes; and
if the received identifier matches any one of the one or more determined validation codes, validate the received identifier.

49. A method of validating an identifier during an electronic transaction between an unauthenticated party device and an authenticating party system in response to receiving an unexpected identifier at the authenticating party system, including:
incrementing a counter from a current count value in each of a plurality of successive iterations up to a predetermined number of iterations;
for each of the successive iterations:
determining a validation code corresponding with the incremented counter value;
comparing the received identifier with the validation code associated with the incremented counter value; and
in the event that the identifier matches the validation code associated with the incremented counter value, validating the identifier and storing the incremented counter value as the current count value.

50. A method of validating an identifier during an electronic transaction between an unauthenticated party and an authenticating party, including:
an authenticating party system receiving the identifier for validation;
determining, by the authenticating party system, a first validation code associated with a current value of a counter;
comparing the received identifier with the first validation code;
responsive to the comparison, and in the event that the identifier does not match the first validation code, the authenticating party system comparing the identifier with one or more further validation codes, each further validation code associated with a respective other value for the counter from within a validation window of counter values; and
validating the identifier if the identifier matches one of the further validation codes.

51. A method according to claim 50, wherein the validation window includes N consecutive values for the counter succeeding the current value of the counter.

52. A method according to claim 51, further including:
if the identifier matches one of the further validation codes associated with a respective other value for the counter, updating the current value of the counter to correspond with the respective other value.

53. A method according to claim 50, further including, after comparing the identifier with each of the one or more further validation codes:
for each further validation code compared with the identifier which does not match the identifier, storing the further validation code for validating a later received identifier.

54. A method according to claim 53, further including associating a validity period with the or each stored further validation code, the validity period setting a time constraint for using the or each stored further validation code to validate the later received identifier.

55. A method according to claim 50, wherein a size of the validation window is adjustable.

56. A method according to claim 55, wherein adjusting the size of the validation window includes reducing the size of the validation window.

57. A method according to claim 55, wherein adjusting the size of the validation window includes adjusting the size based on one or more of:
a time period since a first validation attempt;
a predetermined number of validation attempts;
a risk score for the unauthenticated party; and
a previous validation failure.

58. A method according to claim 50, wherein comparing the identifier with one or more further validation codes associated with respective other values for the counter includes:
comparing the identifier with one or more stored further validation codes associated with respective other values for the counter, said respective other values being values which precede the current value of the counter.

59. A method according to claim 50, further including, in the event that the identifier does not match one of the further validation codes:
comparing the received identifier with one or more additional validation codes, each additional validation code associated with a respective counter value for the counter from within a window of counter values succeeding the validation window;
determining that the identifier matches one of the additional validation codes;
receiving a further identifier for validation;
comparing the further identifier with one or more others of the additional validation codes; and
responsive to the comparison, and in the event that the further identifier matches one of the other additional validation codes, validating the further identifier and updating the current value of the counter to correspond with the counter value associated with the additional validation code matching the further identifier.

60. A method according to claim 59 wherein comparing the further identifier with one or more others of the additional validation codes includes comparing the further identifier with the additional validation code associated with the counter value succeeding the counter value associated with the additional validation code matching the identifier.

61. A method according to claim 50, wherein the received identifier includes an identifier generated by an unauthenticated party operating a user device to execute a code generation algorithm with a local counter value stored on the user device as an input, and wherein determining the first validation code includes executing at the authenticating party system the same code generation algorithm with the current value of the counter.

62. A method according to claim 61, further including, prior to comparing the identifier with a further validation code, generating the further validation code for comparison at the authenticating party system by executing the code generation algorithm using the counter value as an input.

63. A method according to claim 50, wherein said respective other values from within the validation window of counter values comprises N consecutive counter values succeeding the current value of the counter; and
in the event that the identifier matches one of the further validation codes associated with one of the respective other values for the counter, updating the current value of the counter to correspond with the respective other value for the counter associated with the matching further validation code.

64. A method according to claim 63, further including, in the event that the identifier does not match one of the further validation codes:
comparing the received identifier with one or more additional validation codes, each additional validation code associated with a respective further value for the counter;
determining that the identifier matches one of the additional validation codes;
receiving a further identifier for validation;
comparing the further identifier with one or more others of the additional validation codes;
responsive to the comparison, and in the event that the further identifier matches one of the one or more others of the additional validation codes, validating the further identifier and updating the current value of the counter to correspond with the counter value associated with the additional validation code matching the further identifier.

65. Software for use with an authenticating party system including a processor and associated memory for storing the software, the software including a series of instructions executable by the processor to carry out a method according to claim 34.

66. A device for validating an identifier by an authenticating party system, the device comprising:
a processor configured to generate the identifier and communicate the identifier to the authenticating party system such that the authenticating party system, upon receipt of the identifier, determines one or more validation codes corresponding to respective one or more counter values for a counter; compares the identifier with at least one of the one or more validation codes; and if the identifier matches any one of the one or more validation codes, validates the identifier.
